(19) United States
(12) Patent Application Publication
(10) Pub. No.: US 2002/0114984 A1
(43) Pub. Date: Aug. 22, 2002

(54) Fuel cell system with stored hydrogen

(76) Inventors: David J. Edlund, Bend, OR (US); William A. Pledger, Sisters, OR (US)

Correspondence Address: KOLISCH HARTWELL DICKINSON MCCORMACK &, HEUSER, 520 S.W. YAMHILL STREET, SUITE 200, PORTLAND, OR, 97204, US

(21) Appl. No.: 09/929,280

(22) Filed: Aug. 13, 2001

Related U.S. Application Data
(60) Provisional application No. 60/270,492, filed on Feb. 21, 2001.

(51) Int. Cl. H01M 8/06; H01M 8/04

(52) U.S. Cl. 429/19; 429/34; 429/22

(57) ABSTRACT

An improved method and apparatus for quickly supplying hydrogen gas from a fuel processor, which in some embodiments is supplied to a fuel cell stack. The fuel cell system includes one or more fuel processors adapted to produce a product hydrogen stream, and one or more fuel cell stacks adapted to produce an electric current from the product hydrogen stream. The fuel cell system further includes a hydrogen storage device adapted to store hydrogen gas produced by the fuel processor(s) and deliver the stored hydrogen gas to the fuel cell stack(s), such as during times of increased load demand or times when the fuel processor(s) are not available to produce the hydrogen gas required by the fuel cell stack or other hydrogen-consuming device.

### RELATED APPLICATION

This application claims priority to copending U.S. Provisional Patent Application Serial No. 60/270,492, which was filed on Feb. 21, 2001, is entitled “Fuel Cell System with Stored Hydrogen,” and the complete disclosure of which is hereby incorporated by reference for all purposes.

### FIELD OF THE INVENTION

The present invention relates generally to fuel processing systems, which contain a fuel processor adapted to produce hydrogen gas, and fuel cell systems that include a fuel processor and a fuel cell stack, and more particularly to an improved method and system for supplying hydrogen gas to a fuel cell stack or other hydrogen-consuming device.

### BACKGROUND OF THE INVENTION

Fuel processing systems include a fuel processor that produces hydrogen gas or hydrogen-rich gas from common fuels such as a carbon-containing feedstock, and fuel cell systems include a fuel processor and a fuel cell stack adapted to produce an electric current from the hydrogen gas. The hydrogen or hydrogen-rich gas produced by the fuel processor is fed to the anode region of the fuel cell stack, air is fed to the cathode region of the fuel cell stack, and an electric current is generated. Although typical fuel cell stacks can respond quickly, such as within 1-10 milliseconds, to an increase in load demand, typical fuel processors often take several minutes or longer to ramp up to meet a large increase in load demand. Because of the relatively long time period required for the fuel processor to respond to an increase in load demand, fuel cell systems incorporating a fuel processor usually exhibit poor transient response characteristics.

### SUMMARY OF THE INVENTION

The present invention is directed to an improved method and apparatus for quickly supplying hydrogen gas from a fuel processor, which in some embodiments is supplied to a fuel cell stack. The fuel cell system includes one or more fuel processors adapted to produce a product hydrogen stream, and one or more fuel cell stacks adapted to produce an electric current from the product hydrogen stream. The fuel cell system further includes a hydrogen storage device adapted to store hydrogen gas produced by the fuel processor(s) and deliver the stored hydrogen gas to the fuel cell stack(s), such as during times of increased load demand or times when the fuel processor(s) are not available to produce the hydrogen gas required by the fuel cell stack or other hydrogen-consuming device.

### BRIEF DESCRIPTION OF THE DRAWINGS

FIG. 1 is a schematic diagram of a hybrid fuel cell system with stored hydrogen according to the present invention.

FIG. 2 is a schematic diagram of another hybrid fuel cell system according to the present invention.

FIG. 3 is a schematic diagram of a fuel processor suitable for use in the system of FIGS. 1 and 2.

FIG. 4 is a schematic diagram of another fuel processor suitable for use in the system of FIGS. 1 and 2.

FIG. 5 is a schematic diagram of another hybrid fuel cell system with stored hydrogen according to the present invention.

FIG. 6 is a schematic diagram of another hybrid fuel cell system with stored hydrogen according to the present invention.

FIG. 7 is a schematic diagram of a suitable controller for use with hybrid systems according to the present invention.

FIG. 8 is a schematic diagram of a user interface for use with a controller according to the present invention.

FIG. 9 is a schematic diagram of a hybrid fuel cell system with stored hydrogen and a controller according to the present invention.

FIG. 10 is a schematic diagram of another hybrid fuel cell system with stored hydrogen and a controller according to the present invention.

FIG. 11 is a schematic diagram of a self-contained fuel cell system according to the present invention and of an energy-consuming device integrated with a fuel cell system according to the present invention.

### DETAILED DESCRIPTION AND BEST MODE OF THE INVENTION

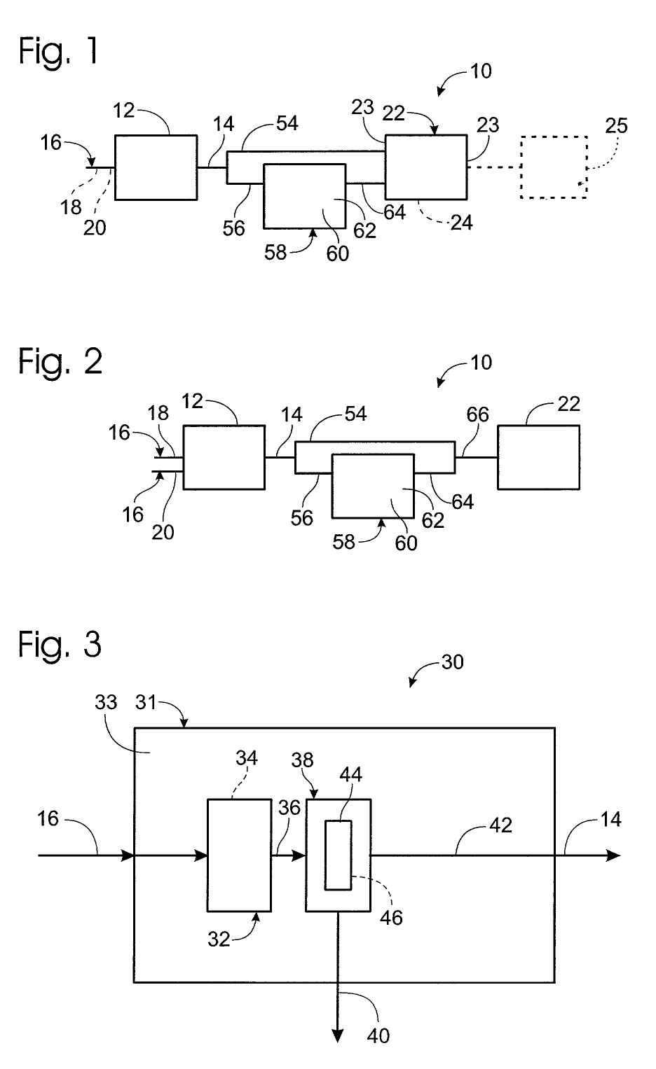

A fuel cell system according to the present invention is shown in FIG. 1 and generally indicated at 10. System 10 includes at least one fuel processor 12, at least one fuel cell stack 22 and a hydrogen storage system 58. Fuel processor 12 is adapted to produce a product hydrogen stream 14 containing hydrogen gas from a feed stream 16 containing a feedstock. The fuel cell stack is adapted to produce an electric current from the portion of product hydrogen stream 14 delivered thereto. In the illustrated embodiment, a single fuel processor 12 and fuel cell stack 22 is shown and described, however, it should be understood that more than one of either or both of these components may be used. It should also be understood that these components have been schematically illustrated and that the fuel cell system may include additional components that are not specifically illustrated in the figures, such as feed pumps, air delivery systems, heat exchangers, and the like.

The product hydrogen stream from fuel processor 12 is selectively delivered to either or both of fuel cell stack 22 and hydrogen storage system 58, which in turn may provide the stored hydrogen gas to fuel cell stack 22. As such, the fuel cell system may be referred to as a hybrid fuel cell system. Hydrogen storage system 58 is adapted to selectively store the hydrogen gas delivered thereto. The stored hydrogen may then be selectively removed from the system and delivered to the fuel cell stack to produce an electric current therefrom, to the fuel processor for use as a combustion fuel, or to another hydrogen-consuming device.

As shown in FIG. 1, product hydrogen stream 14 is divided by a suitable valve assembly or flow controller into two streams, namely a product hydrogen stream 54, which is delivered to fuel cell stack 22, and a hydrogen slipstream 56, which is delivered to hydrogen storage system 58. In FIG. 1, stored hydrogen stream 64 and product hydrogen stream 54 are separately delivered to feed fuel cell stack 22. Alternatively, streams 64 and 54 may be combined to form hydrogen stream 66, such as shown in FIG. 2.

Fuel processor 12 produces hydrogen gas through any suitable mechanism. Examples of suitable mechanisms include steam reforming and autothermal reforming, in which reforming catalysts are used to produce hydrogen gas from a feed stream containing a carbon-containing feedstock and water. Other suitable mechanisms for producing hydrogen gas include pyrrolysis and catalytic partial oxidation of a carbon-containing feedstock, in which case the feed stream does not contain water. Still another suitable mechanism for producing hydrogen gas is electrolysis in which the feedstock is water.

For purposes of illustration, the following discussion will describe fuel processor 12 as a steam reformer adapted to receive a feed stream 16 containing a carbon-containing feedstock 18 and water 20. However, it is within the scope of the invention that the fuel processor 12 may take other forms, as discussed above.

Examples of suitable carbon-containing feedstocks include at least one hydrocarbon or alcohol. Examples of suitable hydrocarbons include methane, propane, natural gas, diesel, kerosene, gasoline and the like. Examples of suitable alcohols include methanol, ethanol, and polyols, such as ethylene glycol and propylene glycol.

Feed stream 16 may be delivered to fuel processor 12 via any suitable mechanism. Although only a single feed stream 16 is shown in FIG. 1, it should be understood that more than one stream 16 may be used and that these streams may contain the same or different components. When carbon-containing feedstock 18 is miscible with water, the feedstock is typically delivered with the water component of feed stream 16, such as shown in FIG. 1. When the carbon-containing feedstock is immiscible or only slightly miscible with water, these components are typically delivered to fuel processor 12 in separate streams, such as shown in FIG. 2.

Fuel cell stack 22 contains at least one, and typically multiple, fuel cells 24 adapted to produce an electric current from the portion of the product hydrogen stream 14 delivered thereto. This electric current may be used to satisfy the energy demands, or applied load, of an associated energy-consuming device 25. Illustrative examples of devices 25 include, but should not be limited to, a motor vehicle, recreational vehicle, boat, tools, lights, appliances, household, signaling or communication equipment, etc. It should be understood that device 25 is schematically illustrated in FIG. 1 and is meant to represent one or more devices or collection of devices that are adapted to draw electric current from the fuel processing system. A fuel cell stack typically includes multiple fuel cells joined together between common end plates 23, which contain fluid delivery/removal conduits (not shown). Examples of suitable fuel cells include proton exchange membrane (PEM) fuel cells and alkaline fuel cells. Fuel cell stack 22 may receive all of product hydrogen stream 14. Some or all of stream 14 may additionally, or alternatively, be delivered, via a suitable conduit, for use in another hydrogen-consuming process, burned for fuel or heat, or stored for later use, such as by hydrogen storage system 58.

Fuel processor 12 is any suitable device that produces hydrogen gas. Preferably, the fuel processor is adapted to produce substantially pure hydrogen gas, and even more preferably, the fuel processor is adapted to produce pure hydrogen gas. For the purposes of the present invention, substantially pure hydrogen gas is greater than 90% pure, preferably greater than 95% pure, more preferably greater than 99% pure, and even more preferably greater than 99.5% pure. Suitable fuel processors are disclosed in U.S. Pat. Nos. 5,997,594 and 5,861,137, pending U.S. patent application Ser. No. 09/291,447, which was filed on Apr. 13, 1999, and is entitled “Fuel Processing System,” and U.S. Provisional Patent Application Ser. No. 60/188,993, which was filed on Mar. 13, 2000 and is entitled “Fuel Processor,” each of which is incorporated by reference in its entirety for all purposes.

An example of a suitable fuel processor 12 is a steam reformer. An example of a steam reformer is shown in FIG. 3 and indicated generally at 30. Reformer 30 includes a reforming, or hydrogen-producing, region 32 that includes a steam reforming catalyst 34. Alternatively, reformer 30 may be an autothermal reformer that includes an autothermal reforming catalyst. In reforming region 32, a reformate stream 36 is produced from the water and carbon-containing feedstock forming feed stream 16. The reformate stream typically contains hydrogen gas and impurities, and therefore is delivered to a separation region, or purification region, 38, where the hydrogen gas is purified. In separation region 38, the hydrogen-containing stream is separated into one or more byproduct streams, which are collectively illustrated at 40, and a hydrogen-rich stream 42 by any suitable pressure-driven separation process. In FIG. 3, hydrogen-rich stream 42 is shown forming product hydrogen stream 14.

An example of a suitable structure for use in separation region 38 is a membrane module 44, which contains one or more hydrogen permeable metal membranes 46. Examples of suitable membrane modules formed from a plurality of hydrogen-selective metal membranes are disclosed in U.S. patent application Ser. No. 09/291,447, which was filed on Apr. 13, 1999, is entitled “Fuel Processing System,” and the complete disclosure of which is hereby incorporated by reference in its entirety for all purposes. In that application, a plurality of generally planar membranes are assembled together into a membrane module having flow channels through which an impure gas stream is delivered to the membranes, a purified gas stream is harvested from the membranes and a byproduct stream is removed from the membranes. Gaskets, such as flexible graphite gaskets, are used to achieve seals around the feed and permeate flow channels. Also disclosed in the above-identified application are tubular hydrogen-selective membranes, which also may be used. Other suitable membranes and membrane modules are disclosed in U.S. patent application Ser. No. 09/618,866, which was filed on Jul. 19, 2000 and is entitled “Hydrogen-Permeable Metal Membrane and Method for Producing the Same,” the complete disclosure of which is hereby incorporated by reference in its entirety for all purposes. Other suitable fuel processors are also disclosed in the incorporated patent applications.

The thin, planar, hydrogen-permeable membranes are preferably composed of palladium alloys, most especially palladium with 35 wt % to 45 wt % copper. These membranes, which also may be referred to as hydrogen-selective membranes, are typically formed from a thin foil that is approximately 0.001 inches thick. It is within the scope of the present invention, however, that the membranes may be formed from hydrogen-selective metals and metal alloys other than those discussed above, hydrogen-permeable and selective ceramics, or carbon compositions. The membranes may have thicknesses that are larger or smaller than discussed above. For example, the membrane may be made thinner, with commensurate increase in hydrogen flux. The hydrogen-permeable membranes may be arranged in any suitable configuration, such as arranged in pairs around a common permeate channel as is disclosed in the incorporated patent applications. The hydrogen permeable membrane or membranes may take other configurations as well, such as tubular configurations, which are disclosed in the incorporated patents.

Another example of a suitable pressure-separation process for use in separation region 38 is pressure swing absorption (PSA). In a pressure swing adsorption (PSA) process, gaseous impurities are removed from a stream containing hydrogen gas. PSA is based on the principle that certain gases, under the proper conditions of temperature and pressure, will be adsorbed onto an adsorbent material more strongly than other gases. Typically, it is the impurities that are adsorbed and thus removed from reformate stream 36. The success of using PSA for hydrogen purification is due to the relatively strong adsorption of common impurity gases (such as CO, CO₂, hydrocarbons including CH₄, and N₂) on the adsorbent material. Hydrogen adsorbs only very weakly and so hydrogen passes through the adsorbent bed while the impurities are retained on the adsorbent. Impurity gases such as NH₃, H₂S, and H₂O adsorb very strongly on the adsorbent material and are therefore removed from stream 36 along with other impurities. If the adsorbent material is going to be regenerated and these impurities are present in stream 36, separation region 38 preferably includes a suitable device that is adapted to remove these impurities prior to delivery of stream 36 to the adsorbent material because it is more difficult to desorb these impurities.

Adsorption of impurity gases occurs at elevated pressure. When the pressure is reduced, the impurities are desorbed from the adsorbent material, thus regenerating the adsorbent material. Typically, PSA is a cyclic process and requires at least two beds for continuous (as opposed to batch) operation. Examples of suitable adsorbent materials that may be used in adsorbent beds are activated carbon and zeolites, especially 5 Å (5 angstrom) zeolites. The adsorbent material is commonly in the form of pellets and it is placed in a cylindrical pressure vessel utilizing a conventional packed-bed configuration. It should be understood, however, that other suitable adsorbent material compositions, forms and configurations may be used.

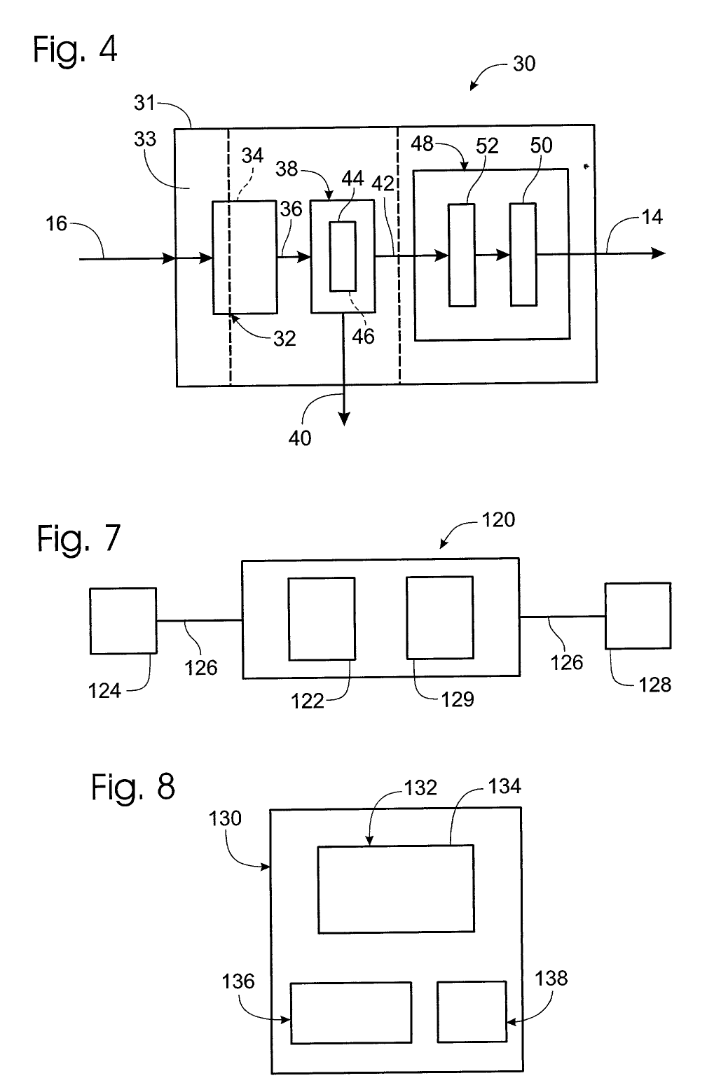

Reformer 30 may, but does not necessarily, further include a polishing region 48, such as shown in FIG. 4. Polishing region 48 receives hydrogen-rich stream 42 from separation region 38 and further purifies the stream by reducing the concentration of, or removing, selected compositions therein. For example, when stream 42 is intended for use in a fuel cell stack, such as stack 22, compositions that may damage the fuel cell stack, such as carbon monoxide and carbon dioxide, may be removed from the hydrogen-rich stream. Region 48 includes any suitable structure for removing or reducing the concentration of the selected compositions in stream 42. For example, when the product stream is intended for use in a PEM fuel cell stack or other device that will be damaged if the stream contains more than determined concentrations of carbon monoxide or carbon dioxide, it may be desirable to include at least one methanation catalyst bed 50. Bed 50 converts carbon monoxide and carbon dioxide into methane and water, both of which will not damage a PEM fuel cell stack. Polishing region 48 may also include another hydrogen-producing device 52, such as another reforming catalyst bed, to convert any unreacted feedstock into hydrogen gas. In such an embodiment, it is preferable that the second reforming catalyst bed is upstream from the methanation catalyst bed so as not to reintroduce carbon dioxide or carbon monoxide downstream of the methanation catalyst bed.

In FIGS. 3 and 4, reformer 30 is shown including a shell 31 in which the above-described components are contained. Shell 31, which also may be referred to as a housing, enables the fuel processor, such as reformer 30, to be moved as a unit. It also protects the components of the fuel processor from damage by providing an exterior cover and reduces the heating demand of the fuel processor because the components of the fuel processor may be heated as a unit, and heat generated by one component may be used to heat other components. Shell 31 may, but does not necessarily, include an interior layer of an insulating material 33, such as a solid insulating material or an air-filled cavity. It is within the scope of the invention, however, that the reformer may be formed without a housing or exterior shell, or alternatively, that one or more of the components may either extend beyond the shell or be located external the shell. For example, and as schematically illustrated in FIG. 3, polishing region 48 may be external shell 31 and/or a portion of reforming region 32 may extend beyond the shell. Other examples of fuel processors demonstrating these configurations are illustrated in the incorporated references.

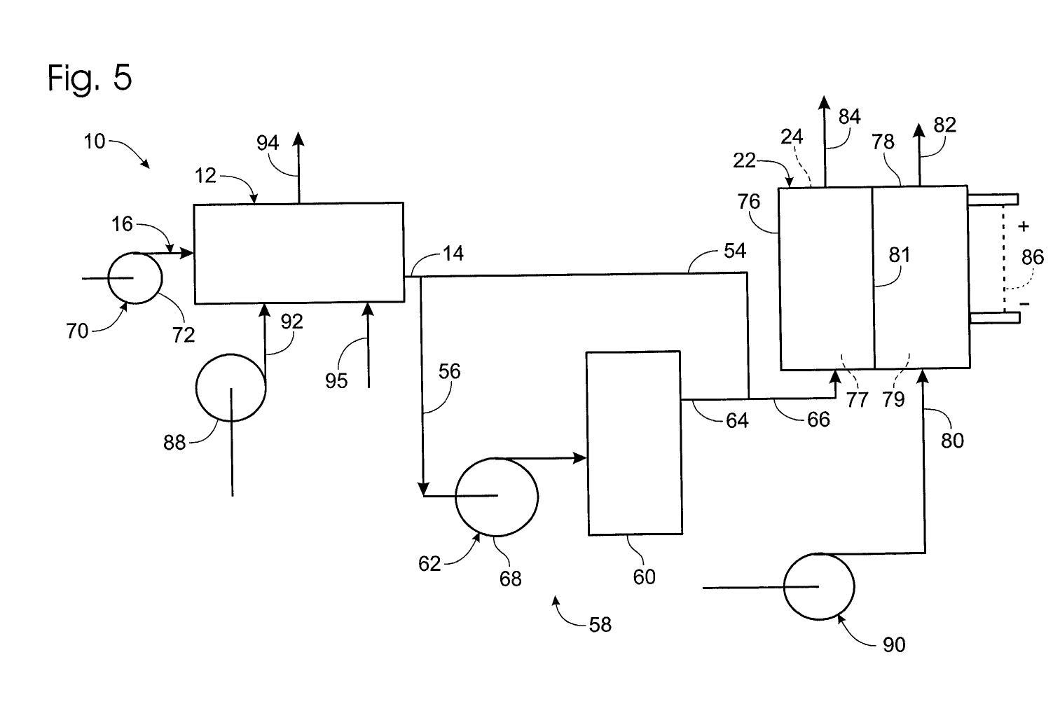

Referring back to FIGS. 1 and 2, it can be seen that hydrogen storage system 58 includes at least one hydrogen storage device 60 that is adapted to store the portion of product hydrogen stream 14 that is delivered thereto and then selectively release the stored hydrogen gas, such as for delivery to fuel cell stack 22, to fuel processor 12 for use as a fuel stream, or to another hydrogen-consuming device. Device 60 therefore may provide a hydrogen gas stream to be used as a feed stream for fuel cell stack 22, either in place of or in addition to a stream from fuel processor 12. The hydrogen storage device is recharged by hydrogen gas from the fuel processor. This removes the requirement for the storage device to be removed and replaced for recharging, such as would be required with compressed gas cylinders that are simply used as a backup for the fuel processor's hydrogen stream, but which are not recharged by the fuel processor. System 58 may, but does not in all embodiments, include a hydrogen compressor 62, which is any suitable device for compressing stream 56 prior to delivery of the stream to the hydrogen storage device. An example of such as system is shown in FIG. 5.

An example of a suitable hydrogen storage device 60 is a compressed gas cylinder. Other suitable hydrogen storage devices include metal hydride beds and activated carbon beds, such as beds including carbon nanotubes. Metal hydride beds provide an example of a hydrogen storage device that does not require a hydrogen compressor. Metal hydride beds absorb hydrogen gas at relatively low pressures and temperatures, and then desorb this gas at elevated temperatures and pressures. It is within the scope of the invention that system 58 may include multiple hydrogen storage devices 60. For example, the hydrogen storage system may include multiple compressed gas cylinders, multiple hydride or carbon beds, or a combination thereof.

When storage device 60 utilizes a compressed gas cylinder, hydrogen storage system 58 may include a hydrogen compressor 62 in the form of a mechanical gas compressor 68 that receives and mechanically compresses the volume of gas received therein. Unlike an electrochemical compressor that may be selected to remove a selected component from stream 56, such as hydrogen gas, a mechanical compressor compresses the entire stream. When fuel processor 12 is adapted to produce a product hydrogen stream of pure or essentially pure hydrogen gas, the mechanical compressor may be used. In embodiments where the product stream is of a lesser purity, it may be necessary to use an electrochemical compressor that removes a selected component, namely hydrogen, of the product hydrogen stream, or to further purify the portion of the product hydrogen stream before it is compressed.

More specifically, applying pressure to an impure stream containing hydrogen, carbon monoxide and carbon dioxide, especially in the presence of catalysts such as iron, chromium or nickel, drives the formation of methane and water. Water will condense and corrode or remove lubricants from a mechanical compressor and deactivate a hydride bed by reacting with the metal hydride. Formation of methane represents a loss of hydrogen gas.

An advantage of a compressed gas cylinder is that hydrogen gas stored within may be quickly released, such as responsive to an increased load applied to fuel cell stack 22. For example, a compressed gas cylinder can respond to an increase in applied load within fractions of a second, while a hydride bed, which requires elevated temperature and pressure to desorb hydrogen gas, will take much longer, thereby providing a system with a slower response time. Similarly, the control structure and energy requirements to quickly heat and cool the hydride bed are more significant than required to remove hydrogen gas from a compressed gas cylinder. Nonetheless, compressed gas cylinders, hydride beds and other suitable structures for storing hydrogen gas are all within the scope of the present invention.

The distribution of product hydrogen stream 14 between the hydrogen storage device and fuel cell stack may range from all of the stream going to the fuel cell stack to all of the stream going to the hydrogen storage device. The relative division of stream 14 may be controlled or selected by any suitable mechanism, including manually controlled valve assemblies, or valve assemblies that vary the relative distribution responsive to inputs from sensors associated with the fuel cell system. These inputs may be in the form of either mechanical inputs or control signals, which may be transmitted through any suitable wired or wireless mechanism.

In FIG. 5, feed stream 16 is shown being delivered to fuel processor 12 by a feed stream delivery system 70. Delivery system 70 is any suitable mechanism or device that delivers the feed stream to fuel processor 12. For example, in the illustrated embodiment, the delivery system is shown including one or more pumps 72 that deliver the components of stream 16 from a supply. Additionally, or alternatively, system 70 may include a valve assembly adapted to regulate the flow of the components from a pressurized supply. Other components that may be, but are not necessarily, used in fuel cell system 10 are shown.

In FIG. 5, an illustrative example of a fuel cell stack is shown. Stack 22 (and the individual fuel cells 24 contained therein) includes an anode region 76 and a cathode region 78, which are separated by an electrolytic membrane or barrier 81 through which hydrogen ions may pass. The regions respectively include anode and cathode electrodes 77 and 79. The anode region 76 of the fuel cell stack receives hydrogen stream 66. Cathode region 78 of the fuel cell stack 22 receives an air stream 80, and releases a cathode air exhaust stream 82 that is partially or substantially depleted in oxygen. Electrons liberated from the hydrogen gas cannot pass through barrier 81, and instead must pass through an external circuit 86, thereby producing an electric current that may be used to meet the electrical load applied by the one or more devices 25, as well as to power the operation of the fuel cell system.

Anode region 76 is periodically purged, and releases a purge stream 84, which may contain hydrogen gas. Alternatively, hydrogen gas may be continuously vented from the anode region of the fuel cell stack and re-circulated. An electric current is produced by fuel cell stack 22 to satisfy an applied load, such as from device 25. Also shown in FIG. 5 are air delivery assemblies 88 and 90, which are respectively adapted to deliver air streams 92 and 80 to fuel processor 12, such as to a combustion region from which a combustion exhaust stream 94 exits, and to fuel cell stack 22, such as to cathode region 78. Air delivery assemblies 88 and 90 are schematically illustrated in FIG. 5 and may take any suitable form.

A combustion fuel stream 95 is schematically illustrated in FIG. 5. It should be understood that stream 95 may be formed from any suitable combustion fuel and may include some or all of one or more of the following: byproduct stream 40 from fuel processor 12, feed stream 16, or a slipstream of a component thereof, such as a stream containing carbon-containing feedstock 18, stored hydrogen gas from hydrogen storage system 58, vented gas from product hydrogen streams 14, 54, 56, 64 or 66, a fuel stream independent of the feed stream 16 or the byproduct streams from system 10, such as a supply of a suitable fuel, such as propane, gasoline, kerosene, diesel, natural gas, etc. Stream 95 may alternatively indicate an electric current to an electrical heating device, such as a resistive heater, as opposed to a combustive heating source, such as a burner, combustion catalyst, spark plug, glow plug, pilot light, or the like.

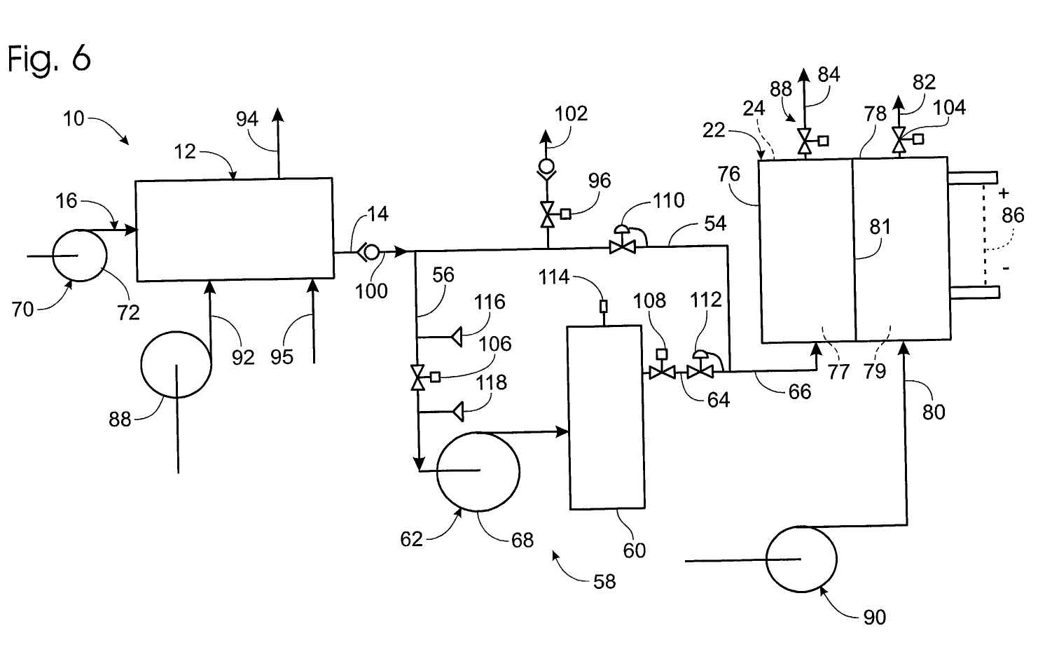

In FIG. 6, various flow-regulating devices are shown to illustrate that these devices may be, but are not necessarily, included in system 10. For example, a vent assembly 96 is shown upstream of the fuel cell stack. Vent assembly 96 is adapted to remove the product stream from fuel processor 12 from fluid communication with fuel cell stack 22, such as if the stream becomes contaminated, exists at an operating parameter outside of acceptable operating parameters (such as elevated pressure), if the fuel cell stack is not operational or cannot safely accept the additional hydrogen gas present in stream 54, or if there is an excess of hydrogen gas in the system. Vent assembly 96 may release hydrogen gas to the environment, to another storage or hydrogen-consuming device, to a burner, or to another location other than to fuel cell stack 22. Another vent assembly 98 is shown in communication with stream 84. Vent assemblies 96 and 98 typically include at least one valve, such as a solenoid valve or other suitable flow-controlling device, and may be configured to be automatically actuated when the pressure or other operating parameter of the corresponding stream or portion of fuel cell system 10, such as stream 54 and anode region 76, exceeds a threshold value or range of values. In FIG. 6, vent assembly 96 is configured to vent stream 54. It should be understood that this positioning is an illustrative example of a suitable position, and that system 10 may include the vent assembly positioned elsewhere in the system, such as to vent from stream 66, or that the system may include more than one vent assembly.

Check valves 100 and 102 are shown downstream of fuel processor 12 and vent assembly 96. The check valves ensure that fluids flow through these fluid conduits in only the desired direction, namely downstream from fuel processor 12 and out of the fuel cell system from vent assembly 96. Throttle valve 104 provides the required degree of backpressure on cathode air stream 80. Valve assemblies 106 and 108 are respectively upstream and downstream of hydrogen storage system 58 and enable the flow of hydrogen gas to and from the hydrogen storage device

Also shown in FIG. 6 are pressure regulators 110 and 112 that are adapted to control the pressure of hydrogen gas in streams 54 and 64, and a pressure switch or pressure transducer 114 in communication with storage device 60. Alternatively, a single regulator on stream 66 may be used in place of, or in addition to, the pair of regulators associated with streams 54 and 64. Any suitable pressure-regulating device may be used, such as a pressure-by-pressure regulator, a pressure regulator that is configured to automatically reduce the downstream pressure to a predetermined level, or a controlled pressure regulator, as discussed in more detail subsequently.

Pressure transducers 116 and 118 measure the hydrogen pressure on either side of valve assembly 106. When compressor 62 is turned on, initially the hydrogen pressure immediately upstream of the compressor will decrease. Pressure transducer 116 detects this decrease in pressure, and valve assembly 106 may be configured to automatically open responsive to transducer 116 detecting this decrease in pressure and registering a lower hydrogen pressure than is registered by pressure transducer 118. Hydrogen gas is then compressed and delivered to hydrogen storage device 60. Pressure transducers 116 and 118 may be eliminated and valve assembly 106 may be adapted to open upon actuation of compressor 62.

It should be understood that the vent assemblies, pressure regulators, check valves, throttle valves and other such flow regulators have been illustrated to provide one of many possible configurations and that the number, type and placement of these regulators may vary, and that it is within the scope of the invention that fuel cell system 10 may be formed without some or even all of these elements.

The fuel cell system of the present invention may, but does not necessarily, include a controller employed to control the operation of hydrogen storage system 58. FIG. 7 is a schematic illustration of a hybrid fuel cell system with stored hydrogen having a controller 120. Unless otherwise indicated, the systems with a controller may have any of the components, elements, subelements and variations shown and described with respect to FIGS. 1-6.

Controller 120 is adapted to monitor selected operating parameters such as pressures, temperatures, and flow rates of components of the hydrogen storage system and/or the fuel cell system and direct the relative flow of hydrogen gas from hydrogen storage system 58 at least partially in response to monitored values. For example, during normal operation of the system, an increase in the electrical load demand placed on the fuel cell stack by device 25 is detected by the controller, such as with a current sensor or a power sensor. The controller uses this load demand information to determine whether the fuel processor alone is supplying sufficient hydrogen gas to the fuel cell stack. If the load demand is of a magnitude that exceeds the current capability of the fuel processor to supply hydrogen gas to the fuel cell stack, then the controller directs additional flow of hydrogen gas to the fuel cell stack from hydrogen storage system 58. As another example, the controller may monitor the pressure of the hydrogen gas entering the anode side of the fuel cell stack. If the hydrogen pressure falls below a predetermined value, then the controller may direct that additional hydrogen gas be supplied from the hydrogen storage system. Controller 120 may additionally control the flow of hydrogen gas to hydrogen storage system 58.

An illustrative example of a suitable controller 120 is schematically illustrated in FIG. 7. As shown, the controller includes a processor 122 and one or more sensors 124 that are adapted to measure or detect the selected values, or operating parameters. Illustrative examples of suitable sensors 124 include pressure sensors, flow meters, temperature sensors, ammeters, and sensors adapted to measure the composition of a particular stream. The sensors communicate with the processor via any suitable wired or wireless communication linkage 126, and this communication may be either one- or two-directional. The processor further communicates with one or more controlled devices 128, which accept command signals from the processor and perform an action in response thereto. Illustrative examples of controlled devices 128 include pumps, compressors, heaters, burners, vents, and valve assemblies that include one or more valves. The processor may have any suitable form, such as including a computerized device, software executing on a computer, code, an embedded processor, programmable logic controllers or functionally equivalent devices. The controller may also include any suitable software, hardware, or firmware. For example, the controller may include a memory device 129 in which preselected, preprogrammed and/or user-selected operating parameters are stored. The memory device may include a volatile portion, nonvolatile portion, or both.

It should be understood that the particular form of communication between the processor, sensors and controlled elements may take any suitable configuration. For example, the sensors may constantly or periodically transmit measured values to the processor, which compares these measured values to stored threshold values or ranges of values to determine if the measured value exceeds a preprogrammed or stored value or range of values. If so, the processor may send a command signal to one or more of the controlled devices. In another example, the sensors themselves may measure an operating parameter and compare it to a stored or predetermined threshold value or range of values and send a signal to the processor only if the measured value exceeds the stored value or range of values. By “exceeds,” it is meant that the measured value deviates from the preselected or stored value or range of values in either direction, and that this deviation may alternatively include a selected tolerance, such a deviation by more than 5%, 10%, 25%, etc.

Controller 120 may also include a user interface through which a user may monitor and interact with the operation of the controller. An example of a user interface is shown in FIG. 8 and indicated generally at 130. As shown, interface 130 includes a display region 132 with a screen 134 or other suitable display mechanism in which information is presented to the user. For example, display region 132 may display the current values measured by one or more of sensors 124, the current operating parameters of the system, the stored threshold values or ranges of values. Previously measured values may also be displayed. Other information regarding the operation and performance of the fuel processing system may also be displayed in region 132.

User interface 130 may also include a user input device 136 through which a user communicates with the controller. For example, input device 136 may enable a user to input commands to change the operating state of the fuel cell system, to change one or more of the stored threshold values and/or operating parameters of the system, and/or to request information from the controller about the previous or current operating parameters of the system. Input device 136 may include any suitable device for receiving user inputs, including rotary dials and switches, pushbuttons, keypads, keyboards, a mouse, touch screens, etc. Also shown in FIG. 8 is a user-signaling device 138 that alerts a user when an acceptable threshold level has been exceeded and the fuel cell stack has been isolated. Device 138 may include an alarm, lights, or any other suitable mechanism or mechanisms for alerting users.

It should be understood that it is within the scope of the present invention that the fuel cell system may include a controller without a user interface, and that it is not required for the user interface to include all of the elements described herein. The elements described above have been schematically illustrated in FIG. 8 collectively, however, it is within the scope of the present invention that they may be implemented separately. For example, the user interface may include multiple display regions, each adapted to display one or more of the types of user information described above. Similarly, a single user input device may be used, and the input device may include a display that prompts the user to enter requested values or enables the user to toggle between input screens.

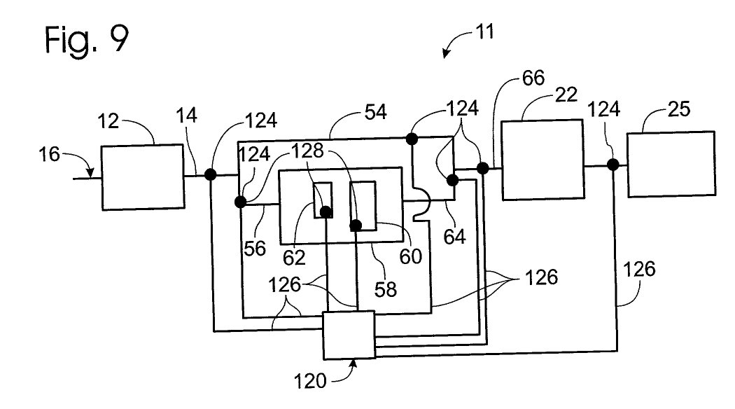

In FIG. 9, controller 120 is shown being in communication with sensors 124 adapted to measure one or more operating parameters of product hydrogen stream 14, hydrogen stream 54, slipstream 56, hydrogen storage device 60, compressor 62, hydrogen stream 64 and hydrogen stream 66. System 10 may include less than all of these communication lines, and may also include many more lines of communication throughout the fuel cell system. Responsive to inputs from these sensors, the controller may control the relative proportion of product stream 14 that is delivered to the hydrogen storage system, such as by sending command signals to valve assembly 106, the flow rate of stored hydrogen gas from device 60, such as by sending control signals to valve assembly 108, or both. When hydrogen storage system 58 includes a compressor 62, the controller may also send control signals to the compressor when it sends control signals to valve assembly 106. Similarly, when storage device 60 includes a hydride bed, the controller may send control signals to a heating device and/or a pressure-regulating device when command signals are sent to valve assembly 108.

For example, when the hydrogen storage device is not fully charged with stored hydrogen gas, it may direct additional hydrogen gas to be delivered thereto from product hydrogen stream 14. Similarly, when the applied load requires greater hydrogen gas than fuel processor 12 is currently supplying, the controller may direct the hydrogen storage device to deliver hydrogen gas to the fuel cell stack to satisfy this demand.

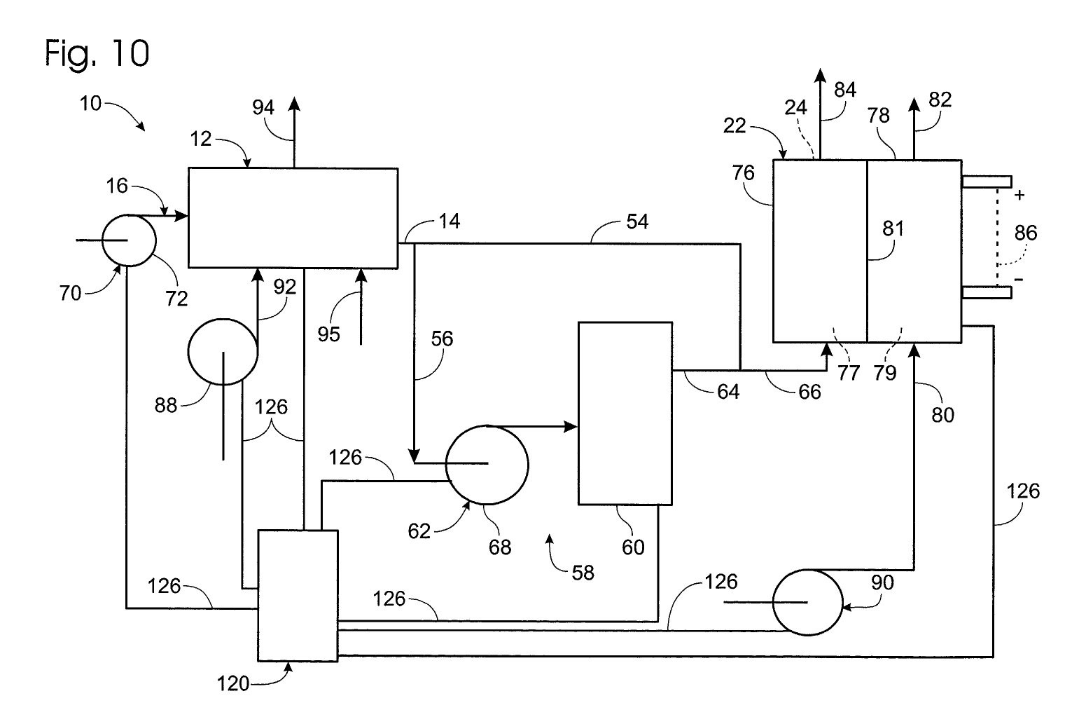

The controller may control aspects of the system not described herein. Furthermore, the controller may control other elements or systems in or out of the fuel processing system including, without limitation, the fuel cell stack, fuel processor, fuel delivery system, or load, such as schematically illustrated in FIG. 10. For example, the controller may be adapted to control the feed stream delivery system 70 to control the rate at which feed stream 16 is delivered to fuel processor 12. By increasing the rate, more hydrogen gas may be generated, and by decreasing the rate, the flow rate of product hydrogen stream 14 may be decreased or stopped. Continuing this example, when the controller detects that additional hydrogen gas is required to satisfy the load applied to the fuel cell stack and/or to recharge the hydrogen storage device, it may send a command signal to delivery system 70 so that more hydrogen gas is generated. Similarly, when the applied load decreases and/or when storage device 60 is fully, or nearly fully, charged, the controller may cause the flow rate of feed stream 16 to be stopped, or more commonly, decreased, so that less hydrogen gas is produced. As another example, the controller may cause the fuel processor to start up or ramp up its production responsive to the applied load and/or the amount of stored hydrogen in storage device 60. Yet another example is that the controller may limit the applied load from device 25 if the applied load exceeds the then available capacity of system 10, such as is determined by sensors within the system in communication with the controller and/or stored threshold values.

It should be understood that the flow-regulating devices shown in FIG. 6 may also be controlled devices 128 within the scope of the present invention. Pressure transducers 116 and 118 measure the hydrogen pressure on either side of valve assembly 106 and the measured parameters, namely the pressure readings, are sent to controller 120. When compressor 62 is turned on, the hydrogen pressure measured by pressure transducer 118 will decrease relative to the pressure measured by pressure transducer 116. This pressure decrease may serve as a triggering event to initiate the flow of hydrogen slipstream 56 to hydrogen storage system 58. For example, once controller 120 determines that the pressure registered by pressure transducer 118 is lower than the pressure registered by pressure transducer 116, valve assembly 106 is opened. Similarly, if the controller detects, via a suitable sensor assembly, that a component of the fuel cell system is malfunctioning, the product hydrogen stream is contaminated, there is an excess of hydrogen gas in the system, or another potentially damaging condition exists, it may actuate either or both of vent assemblies 96 and 98. For purposes of brevity, communication links between each of the sensing- and flow-regulating devices of the present invention have not been illustrated and the interaction of each of these devices with controller 120 has not been described. It should be understood that the controller may communicate with these devices to determine if portions or all of the fuel cell system are operating within acceptable, predetermined parameters. If not, then the controller may send control signals to various controlled devices within the fuel cell system to bring the parameters back to an acceptable value or within an acceptable range of values, to transition the fuel cell system to a mode of operation in which the current parameters will not damage the system, such as to a lower output, idle or shut-down mode, or both.

For purposes of illustration, and not by way of limitation, the following description is intended to describe operation of the fuel cell system illustrated in FIGS. 9 and 10. Feed stream 16 is supplied to fuel processor 12 via feed stream delivery system 70. As discussed, system 70 may be in communication with controller 120, such as to transmit the flow rate in stream 16 and/or to control the flow rate in stream 16. Combustion air stream 92 supports combustion of a fuel to supply the necessary heat to the fuel processor. Combustion exhaust stream 94 exits the fuel processor and may be used for thermal cogeneration applications such as space heating and water heating. Fuel stream 95 is used to heat the fuel processor to a desired operating temperature, such as controlled by a stored parameter of controller 120. Product hydrogen stream 14 from the fuel processor is divided into two streams 54 and 56 at check valve 100, which may be controlled by controller 120. Hydrogen storage system 58 includes compressor 62 which may be controlled by controller 120 and one or more hydrogen storage devices 60. Hydrogen storage device 60 includes pressure transducer 114, which may communicate with controller 120. As shown, hydrogen slipstream 56 feeds into compressor 62 via valve 106, which may be controlled by controller 120. Pressure transducer 116 monitors the pressure of hydrogen slipstream 56 between check valve 100 and valve assembly 106. Pressure transducer 118 monitors the pressure of hydrogen slipstream 56 between valve assembly 106 and compressor 62. Stored hydrogen gas exits storage system 58 via hydrogen stream 64. Valve assembly 108 and pressure regulator 112, both of which may be controlled by controller 120, respectively control the flow and pressure of stream 64. Streams 64 and 54 combine to form stream 66 and are delivered to fuel cell stack 22. Stream 66 may include one or both of streams 64 and 54 in any proportion. Alternatively, the streams may be delivered separately to stack 22, as discussed herein. Controller 120 may selectively deliver between none and all of hydrogen streams 54 and 64 to fuel cell stack 22 by the above-described system.

Controller 120 may further be used to control appropriate usage of stored hydrogen system 58. Beginning with a cold startup, the controller 120 may be powered on and send a signal to start feeding air and hydrogen to fuel cell stack 22 to produce an electric current to satisfy an applied load. Hydrogen stream 64 is fed from the hydrogen storage system 58 to the anode region 76 of fuel cell stack 22. Air stream 92 is fed to the cathode region 78 of fuel cell stack 22. Until fuel processor 12 is able to start producing suitable amounts of hydrogen gas, hydrogen stream 64 is drawn from hydrogen storage system 58. The length of time during which hydrogen gas is drawn from the hydrogen storage system is dependent upon the particular fuel processor used. Time periods of 1 minute or more, 10 minutes or more, 30 minutes or more, and 60 minutes or more are within the scope of the present invention. When controller 120 detects, via a suitable sensor or sensor assembly 124, that fuel processor 12 is producing sufficient hydrogen gas to satisfy the requirements of fuel cell stack 22, the controller may initiate flow of hydrogen stream 54 and terminate flow of hydrogen stream 64.

The controller 120 may direct slipstream 56 of the product hydrogen stream 14 back to the hydrogen storage system 58 to replenish the stored hydrogen. This may be accomplished by directing the slipstream 56 directly to hydrogen storage device(s) 60 or by directing the slipstream to compressor 62, which then feeds compressed hydrogen to the hydrogen storage device(s). Hydrogen storage device 60 may include one or more sensors in communication with controller 120 to monitor hydrogen levels within the storage device. Once the hydrogen storage device is full, the controller stops the flow of hydrogen from the fuel processor to the hydrogen storage device. If a compressor is used, the controller may also direct the compressor to turn off.

Hydrogen storage system 58 is not limited to satisfying hydrogen demand during start-up or other situations in which the fuel processor is not producing hydrogen gas, such as when the fuel processor is shut down, is off-line, is being repaired or serviced, etc. The system may also be used in times of increased load during normal operation of the fuel processor. In times of increased demand, meaning times when the demand for hydrogen gas by the fuel cell stack exceeds the output of the fuel processor, the stored hydrogen may be used to supplement the supply of hydrogen from the fuel processor to the fuel cell stack. In this case, hydrogen may be supplied to the fuel cell stack from both the fuel processor and the hydrogen storage system. An example of a situation in which this may be desired is when the fuel processor is operating in an idle state or operating at less than its maximum output, and needs to ramp up to an operating state in which more hydrogen gas is produced. Another example is when the fuel processor is operating at its maximum operating state, in which the fuel processor is producing its maximum output of hydrogen gas, yet this output is still lower than the supply of hydrogen gas demanded by fuel cell stack 22.

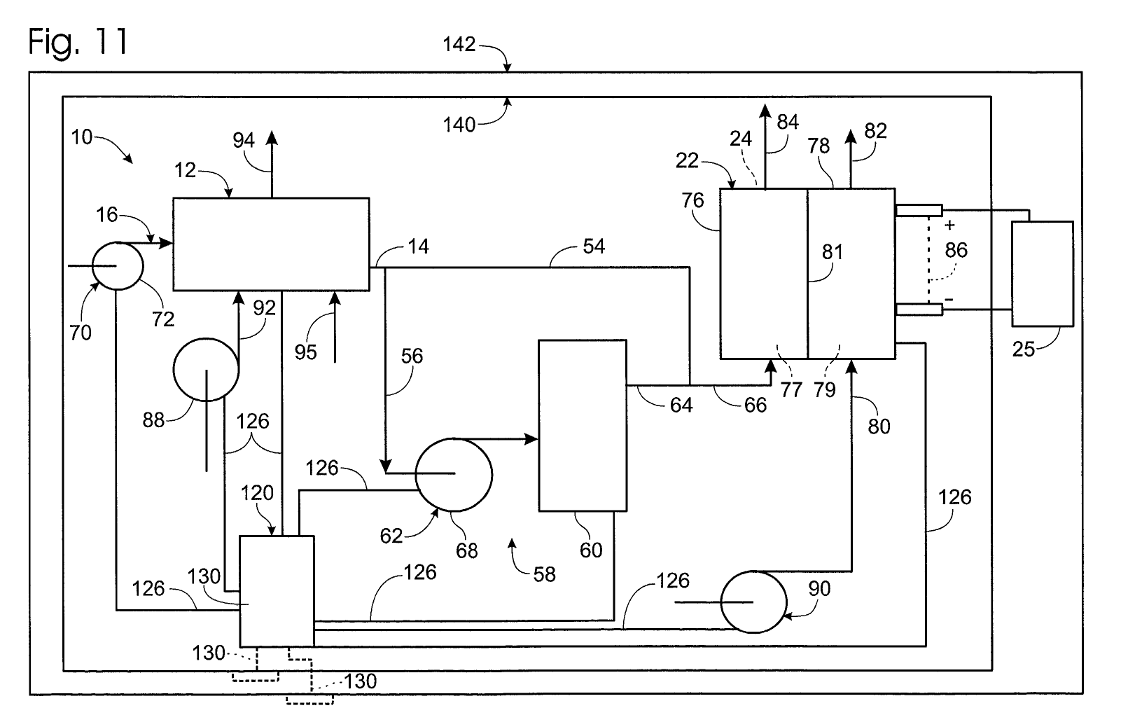

As discussed previously, fuel processor 12 may be contained within a shell or housing. Similarly, fuel cell system 10 may be contained within a housing, such as schematically illustrated in FIG. 11 at 140. For purposes of simplifying the illustration, many of the sensors 124, controlled devices 128 and communication links 126 discussed previously have not been reproduced in FIG. 11. Housing 140 contains fuel processor 12, fuel cell stack 22, and hydrogen storage system 58 and is in at least fluid communication with feed stream delivery system 70, a supply for fuel stream 95 and some or all of controller 120. Housing 140 may alternatively contain one or more of feed stream delivery system 70, the supply for fuel stream 95 and controller 120, such as shown in FIG. 11. In some embodiments, the housing may be sealed so as to completely enclose the above-described elements. By sealed, it is meant that the housing must be at least partially disassembled, such as by removing access panels, to access the above-described components.

In such an embodiment, if the controller includes a user interface 130, at least a portion of the user interface may be accessible from external the housing. In some embodiments, it may be desirable to include another user interface, or portion of a user interface, that is only accessible from within the housing. For example, the externally accessible user interface may be designed to communicate with a user, such as a homeowner, vehicle owner, or others who may not have the skills or training to adjust the stored, or threshold, operating parameters. An internally accessible user interface, however, enables a technician or other trained individual to change, monitor or otherwise control these parameters and other operating conditions, subroutines, controller logic and the like.

Fuel cell system 10 may be combined with an energy-consuming device, such as device 25 to provide the device with an integrated, or on-board, energy source. For example, the body of such a device is schematically illustrated in FIG. 11 at 142. Examples of such devices include a motor vehicle, such as a recreational vehicle, automobile, boat or other seacraft, and the like, a dwelling, such as a house, apartment, duplex, apartment complex, office, store or the like, or a self-contained equipment, such as an appliance, light, tool, microwave relay station, transmitting assembly, remote signaling or communication equipment, etc.

Finally, it is within the scope of the invention that the above-described fuel processor and hydrogen storage system may be used independent of a fuel cell stack. In such an embodiment, the system may be referred to as a hybrid fuel processing system with stored hydrogen, and it may be used to provide a supply of pure or substantially pure hydrogen to a hydrogen-consuming device, such as a burner for heating, cooking or other applications. As discussed above, the hybrid of a fuel processor and a hydrogen storage system provides a more dependable supply of hydrogen gas, and in some embodiments enables the system to satisfy demands that could not be satisfied with the fuel processor alone.

### Industrial Applicability

The present invention is applicable in any fuel processing system or fuel cell system in which hydrogen gas is produced for delivery to a fuel cell stack or other hydrogen-consuming device.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A fuel cell system, comprising:
at least one fuel processor adapted to receive a feed stream and to produce a product hydrogen stream containing at least substantially pure hydrogen gas therefrom;
a hydrogen storage system adapted to receive and selectively store at least a portion of the product hydrogen stream, wherein the hydrogen storage system includes a mechanical compressor adapted to receive at least a portion of the product hydrogen stream and to produce a compressed gas stream therefrom, and at least one hydrogen storage device adapted to receive and selectively store the compressed gas stream; and
at least one fuel cell stack containing a plurality of fuel cells and adapted to receive a stream containing hydrogen gas from at least one of the fuel processor and the hydrogen storage system and to produce an electric current therefrom.

2. The fuel cell system of claim 1, wherein the compressed gas stream and the product hydrogen stream have at least substantially the same composition.

3. The fuel cell system of claim 2, wherein the compressed gas stream and the product hydrogen stream have the same composition.

4. The fuel cell system of claim 1, wherein the hydrogen storage system further includes an electrochemical compressor adapted to receive at least a portion of the product hydrogen stream and to divide the stream into a first portion that is delivered to the mechanical compressor and a second portion that is not delivered to the mechanical compressor.

5. The fuel cell system of claim 1, wherein the hydrogen storage system includes at least one hydrogen storage device in the form of a compressed gas tank.

6. The fuel cell system of claim 5, wherein the fuel processor, the fuel cell stack and the hydrogen storage system are integrated together in a common housing.

7. The fuel cell system of claim 1, wherein the fuel cell system further includes at least one energy-consuming device adapted to draw at least a portion of the electric current from the at least one fuel cell stack.

8. The fuel cell system of claim 7, wherein the fuel processing system, the fuel cell stack and the at least one energy-consuming device are integrated together at least partially within a common housing.

9. The fuel cell system of claim 1, wherein the hydrogen storage system includes at least one pressure-regulating device adapted to selectively deliver at least a portion of the product hydrogen stream to a hydrogen storage device in the hydrogen storage system upon actuation of the mechanical compressor.

10. The fuel cell system of claim 1, wherein the fuel processor includes a hydrogen-producing region in which a stream containing hydrogen gas is produced from the feed stream.

11. The fuel cell system of claim 10, wherein the stream containing hydrogen gas includes hydrogen gas and other gases, wherein the fuel processor includes a separation region in which the stream containing hydrogen gas is separated into a hydrogen-rich stream containing at least substantially pure hydrogen gas and at least one byproduct stream containing at least a substantial portion of the other gases, and further wherein the product hydrogen stream is formed from the hydrogen-rich stream.

12. The fuel cell system of claim 11, wherein the separation region includes at least one hydrogen-permeable membrane.

13. The fuel cell system of claim 12, wherein the separation region includes at least one hydrogen-selective metal membrane.

14. The fuel cell system of claim 13, wherein the at least one hydrogen-selective metal membrane includes at least one of palladium and a palladium alloy.

15. The fuel cell system of claim 11, wherein the separation region is adapted to separate the stream containing hydrogen gas into the hydrogen-rich stream and the at least one byproduct stream through a pressure swing absorption process.

16. The fuel cell system of claim 11, wherein the fuel processor further includes a purification region into which the hydrogen-rich stream is further purified to produce the product hydrogen stream.

17. The fuel cell system of claim 1, wherein the feed stream contains a carbon-containing feedstock and water, and further wherein the fuel processing system includes at least one fuel processor in the form of a steam reformer containing at least one reforming catalyst bed in which the feed stream is converted to a mixed gas stream containing hydrogen gas and other gases.

18. The fuel cell system of claim 1, wherein the feed stream includes a carbon-containing feedstock, and further wherein the fuel cell system contains at least one fuel processor adapted to receive the feed stream and to produce therefrom a stream containing hydrogen gas from which the product hydrogen stream is produced via pyrolysis.

19. The fuel cell system of claim 1, wherein the feed stream includes a water and a carbon-containing feedstock, and further wherein the fuel cell system contains at least one fuel processor adapted to receive the feed stream and to produce therefrom a stream containing hydrogen gas from which the product hydrogen stream is produced via a catalytic partial oxidation of the carbon-containing feedstock.

20. The fuel cell system of claim 1, wherein the feed stream includes water, and further wherein the fuel cell system contains at least one fuel processor adapted to receive the feed stream and to produce therefrom a stream containing hydrogen gas from which the product hydrogen stream is produced via electrolysis.

21. The fuel cell system of claim 1, wherein the fuel cell system further includes a computerized controller adapted to selectively control the operation of the hydrogen storage system.

22. A fuel cell system, comprising:
at least one fuel processor adapted to receive a feed stream and to produce a product hydrogen stream containing at least substantially pure hydrogen gas therefrom;
a hydrogen storage system containing at least one hydrogen storage device adapted to receive and selectively store at least a portion of the product hydrogen stream;
at least one fuel cell stack containing a plurality of fuel cells and adapted to receive a stream containing hydrogen gas from at least one of the fuel processor and the hydrogen storage system and to produce an electric current therefrom; and
a controller adapted to selectively regulate at least one of the delivery of the product hydrogen stream to the hydrogen storage system and the flow of the stream containing hydrogen gas from the hydrogen storage system.

23. The fuel cell system of claim 22, wherein the controller is adapted to regulate the delivery of the product hydrogen stream to the hydrogen storage system and the flow of the stream containing hydrogen gas from the hydrogen storage system.

24. The fuel cell system of claim 22, wherein the controller is adapted to monitor one or more operating parameters of the fuel cell system and to selectively regulate at least one of the delivery of the product hydrogen stream to the hydrogen storage system and the flow of the stream containing hydrogen gas from the hydrogen storage system at least partially in response thereto.

25. The fuel cell system of claim 24, wherein the one or more operating parameters include a load applied to the fuel cell stack.

26. The fuel cell system of claim 24, wherein the one or more operating parameters include the pressure of the stream containing hydrogen gas delivered to the fuel cell stack.

27. The fuel cell system of claim 24, wherein the one or more operating parameters include the flow rate of the product hydrogen stream from the fuel processor.

28. The fuel cell system of claim 24, wherein the one or more operating parameters include the pressure of the product hydrogen stream.

29. The fuel cell system of claim 24, wherein the fuel processor is adapted to have a plurality of operating states, and further wherein the one or more operating parameters include the operating state of the fuel processor.

30. The fuel cell system of claim 24, wherein the one or more operating parameters include the pressure of the stream containing hydrogen gas.

31. The fuel cell system of claim 24, wherein the one or more operating parameters include the quantity of hydrogen gas stored by the hydrogen storage system.

32. The fuel cell system of claim 24, wherein the controller is further adapted to regulate the operation of at least one of the fuel processor and the fuel cell stack at least partially in response to the monitored operating parameters.

33. The fuel cell system of claim 24, wherein the controller includes a sensor assembly containing at least one sensor adapted to measure one or more operating parameters of the fuel cell system.

34. The fuel cell system of claim 33, wherein the sensor assembly includes at least one sensor adapted to communicate with the controller through a communication linkage.

35. The fuel cell system of claim 34, wherein the communication linkage includes a wired communication linkage.

36. The fuel cell system of claim 34, wherein the communication linkage includes a wireless communication linkage.

37. The fuel cell system of claim 22, wherein the controller is a computerized controller.

38. The fuel cell system of claim 24, wherein the controller is a computerized controller.

39. The fuel cell system of claim 38, wherein the controller includes a memory device containing at least one stored threshold value and further wherein the controller is adapted to compare at least one of the monitored operating parameters to the at least one stored threshold value and to selectively regulate at least one of the delivery of the product hydrogen stream to the hydrogen storage system and the flow of the stream containing hydrogen gas from the hydrogen storage system at least partially in response thereto.

40. The fuel cell system of claim 22, wherein the controller includes a user interface with a display, and the controller is adapted to display information on the display.

41. The fuel cell system of claim 40, wherein the information includes measured operating parameters.

42. The fuel cell system of claim 40, wherein the information includes previously measured operating parameters.

43. The fuel cell system of claim 40, wherein the information includes one or more threshold values that are stored in a memory device of the controller.

44. The fuel cell system of claim 22, wherein the controller includes a user interface with at least one user input device adapted to receive user inputs, and further wherein the controller is adapted to selectively regulate the flow of at least one stream containing hydrogen gas to or from the hydrogen storage system at least partially in response to the user inputs.

45. The fuel cell system of claim 22, wherein the hydrogen storage system includes a mechanical compressor adapted to receive and compress at least a portion of the product hydrogen stream prior to delivery of the portion of the product hydrogen stream to the at least one hydrogen storage device.

46. The fuel cell system of claim 45, wherein the hydrogen storage system further includes an electrochemical compressor adapted to receive at least a portion of the product hydrogen stream and to divide the stream into a first portion that is delivered to the mechanical compressor and a second portion that is not delivered to the mechanical compressor.

47. The fuel cell system of claim 22, wherein the hydrogen storage system includes an electrochemical compressor adapted to receive at least a portion of the product hydrogen stream and to divide the stream into a first portion that is delivered to the at least one hydrogen storage device and a second portion that is not delivered to the at least one hydrogen storage device.

48. The fuel cell system of claim 22, wherein the at least one hydrogen storage device includes a compressed gas tank.

49. The fuel cell system of claim 22, wherein the at least one hydrogen storage device includes a hydride bed.

50. The fuel cell system of claim 49, wherein the hydrogen storage system further includes a heating assembly adapted to selectively heat the hydride bed.

51. The fuel cell system of claim 50, wherein the controller is further adapted to control the heating assembly.

52. The fuel cell system of claim 22, wherein the at least one hydrogen storage device includes an activated carbon bed.

53. The fuel cell system of claim 52, wherein the activated carbon bed includes carbon nanotubes.
